(19) United States
(12) Patent Application Publication
(10) Pub. No.: US 2002/0121017 A1
(43) Pub. Date: Sep. 5, 2002

(54) Lithium battery drying aid

(76) Inventors: William J. Labarge, Bay City, MI (US); Daniel G. Young, Davison, MI (US)

Correspondence Address: MARGARET A. DOBROWITSKY, DELPHI TECHNOLOGIES, INC., Legal Staff, P.O. Box 5052 Mail Code: 480-414-420, Troy, MI, 48007-5052, US

(21) Appl. No.: 09/798,745

(22) Filed: Mar. 2, 2001

(51) Int. Cl. H01M 10/04

(52) U.S. Cl. 29/623.2; 29/623.3; 29/623.5

(57) ABSTRACT

A method for fabricating lithium batteries comprising providing a P₂O₅ drying aid between an exterior surface of a cell laminate and an interior surface of a container in which the cell laminate is sealed. A cell laminate is first formed from a transition metal chalcogenide positive electrode and a carbonaceous negative electrode with an electrolyte-containing separator there between. The cell laminate is then sealed in a container together with the P₂O₅ drying aid such that P₂O₅ is available during battery operation to react with moisture generated during charging and discharging of the battery cell.

### FIELD OF THE INVENTION

This invention relates to a method of preparation of lithium batteries, in particular lithium-ion and lithium-ion polymer batteries.

### BACKGROUND OF THE INVENTION

Lithium-ion cells and batteries are secondary (i.e., rechargeable) energy storage devices well known in the art. One such lithium-ion cell is a rocking chair type lithium ion battery. It comprises essentially a carbonaceous anode (negative electrode) that is capable of intercalating lithium ions, a lithium-retentive cathode (positive electrode) that is also capable of intercalating lithium ions, and a non-aqueous, lithium-ion-conducting electrolyte therebetween.

The carbon anode comprises any of the various types of carbon (e.g., graphite, coke, carbon fiber, etc.) which are capable of reversibly storing lithium species, and which are bonded to an electrically conductive current collector (e.g. copper foil) by means of a suitable organic binder (e.g., polyvinyllidene difluoride, PVdF).

The cathode comprises such materials as transition metal chalcogenides that are bonded to an electrically conductive current collector (e.g., aluminum foil) by a suitable organic binder. Chalcogenide compounds include oxides, sulfides, selenides, and tellurides of such metals as vanadium, titanium, chromium, copper, molybdenum, niobium, iron, nickel, cobalt and manganese. Lithiated transition metal oxides are at present the preferred positive electrode intercalation compounds. Examples of suitable cathode materials include LiMnO₂, LiCoO₂ and LiNiO₂, their solid solutions and/or their combination with other metal oxides.

The electrolyte in such lithium-ion cells comprises a lithium salt dissolved in a non-aqueous solvent which may be (1) completely liquid, (2) an immobilized liquid, (e.g., gelled or entrapped in a polymer matrix), or (3) a pure polymer. Known polymer matrices for entrapping the electrolyte include polyacrylates, polyurethanes, polydialkylsiloxanes, polymethacrylates, polyphosphazenes, polyethers, and polycarbonates, and may be polymerized in situ in the presence of the electrolyte to trap the electrolyte therein as the polymerization occurs. Known polymers for pure polymer electrolyte systems include polyethylene oxide (PEO), polymethylenepolyethylene oxide (MPEO), or polyphosphazenes (PPE). Known lithium salts for this purpose include, for example, LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiO₂CF₃, LiAsF₆, and LiSbF₆. Known organic solvents for the lithium salts include, for example, alkylcarbonates (e.g., propylene carbonate, ethylene carbonate), dialkyl carbonates, cyclic ethers, cyclic esters, glymes, lactones, formates, esters, sulfones, nitrites, and oxazolidinones. The electrolyte is incorporated into pores in a separator layer between the cathode and anode. The separator may be glass mat, for example, containing a small percentage of a polymeric material, or may be any other suitable ceramic or ceramic/polymer material. Silica is a typical main component of the separator layer.

Lithium-ion and lithium-ion polymer cells are often made by laminating thin films of the anode, cathode and electrolyte/separator together wherein the electrolyte layer is sandwiched between the anode and cathode layers to form an individual cell, and a plurality of such cells are bundled together to form a higher energy/voltage battery.

During the charge process in these lithium ion rechargeable batteries, lithium ions are deintercalated (or released) from the positive electrode and are intercalated (or inserted) into layer planes of the carbonous material. During the discharge, the lithium ions are released from the negative electrode and are inserted into the positive electrode. For a proper function of this rocking chair type charge-discharge mechanism, the surface compositions and properties of both positive and negative electrodes intercalation compound are of substantial importance. In a battery or a cell utilizing a lithium-containing electrode, it is important to eliminate as many impurities as possible which may affect cell performance. When impurities react with lithium in the cell, there is formed a solid surface layer on the lithium which increases the impedance of the anode. Carbon anodes are also subject to passivation through reaction with cell impurities. The main impurity that contributes to increased cell impedance is water.

It is known in the art that H₂O traces in the electrolyte may produce HF or other hydrogen-containing acids in the electrolyte, which may cause cell component decomposition. Further, the HF may cause precipitation of LiF on the surface of the cell electrodes, which has a blocking effect of lithium intercalation processes on both electrodes. Thus an increase in cell moisture substantially increases electrode impedance and respectively decreases cell power performance and cell capacity at a higher charge-discharge rate.

The anode, electrolyte/separator and cathode materials are all hydroscopic. It is practically impossible to completely dry any component in the battery. First, because this will be impractical and second, because longer drying times as well as handling of materials in totally water free environments is essentially impossible. Also, sometimes water is not simply superficially included in the cell component, but rather it is relatively tightly entrained or bound to the cathode active material, essentially being tightly retained by the cathode active material, for example, lithium manganese oxide. Removing it requires elevated drying temperatures, high enough to decompose elements of the battery or even the active material itself.

Because the source of moisture impurities which cause adverse reaction may be from any component within the cell, including the negative electrode and positive electrode, it is very difficult to completely eliminate the moisture prior to assembly of the completed cell. Even if the anode, separator and cathode materials are rigorously dried, they will absorb water from the casting solvents. Even if the solvents are rigorously dried, the anode, cathode and separator materials will absorb water from the casting room. Even if the casting room is tightly controlled, there is more water adsorbed during solvent extraction of the filler. The electrolyte itself contains some moisture. Vacuum drying of the inorganic materials forms new hydrated compounds that have the water attached as ligands. These water ligands may stay attached even at temperatures above 300° C.

Loss of performance due to moisture impurities has lead to the selection of drying aids, which can remove these waters of hydration. These compounds are used to take up water or hydrolyze with water and then the hydrolysis products are removed before the cell components are assembled. There are 7 commonly used drying aids. The best of these, Na, CaH and LiAlH₄, cannot be used because they react with fluorine and generate H₂. The oxides BaO and CaO are efficient, but they cannot be used because they form the bases Ba(OH)₂ and Ca(OH)₂. The compound MgClO₄ is one of the most efficient, but it cannot be used because it is soluble and it can cause explosions. P₂O₅ is very fast and efficient and can be used in acidic conditions. The byproducts formed are HPO₃, H₃PO₄ and H₄P₂O₇, none of which will interfere with the battery function. However, the addition of P₂O₅ in the formulation of the existing anode, electrolyte/separator or cathode does not fully eliminate moisture impurity because it will be reacted by the time the layers are tape cast and brought into the dry box.

In view of the shortcomings associated with the prior art, there is a need for methods which may drastically further reduce cell moisture content providing cells with improved cycle and calendar life, capacity, and power capability.

### SUMMARY OF THE INVENTION

The present invention provides a method for manufacturing lithium batteries in which a P₂O₅ drying aid is provided in the battery between an exterior surface of the cell laminate and an interior surface of the container subsequent to formation of the cell laminate. The cell laminate comprises a transition metal chalcogenide positive electrode, such as a lithiated manganese oxide, and a carbonaceous negative electrode, such as graphite, separated by an electrolytecontaining layer. In one example of the present invention, the P₂O₅ drying aid is provided by tape casting P₂O₅ and pressing the tape to one or more exterior surfaces of the cell laminate. In another example of the present invention, P₂O₅ is tape cast, and the tape is placed in the container in which the cell laminate is sealed. In yet another example of the present invention, a P₂O₅ slurry is prepared, which is then used to coat either an exterior surface of the cell laminate or an interior surface of the container in which the cell laminate is sealed. The slurry may also be applied to a substrate, and the coated substrate inserted into the container with the cell laminate. By the method of the present invention, a battery is formed in which a P₂O₅ drying aid is present within the battery structure during charging/discharging of the battery so as to be available to react with moisture generated during battery operation. A battery formed by the method of the present invention exhibits a significant improvement in cycle and calendar life, capacity and power capability.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 depicts in cross-sectional view a battery cell of the prior art; and

FIGS. 2-5 depict in cross-sectional view embodiments of battery cells of the present invention containing a P₂O₅ drying aid.

### DETAILED DESCRIPTION

The present invention provides a method for reducing moisture content in an assembled lithium battery cell. To this end, and in accordance with the present invention, P₂O₅ is provided within the sealed cell container to react with water during battery operation. The P₂O₅ is applied either to the assembled cell laminate or to the interior of the cell container. Thus, the P₂O₅ drying aid is not incorporated into individual cell components prior to assembly of the cell laminate, and therefore, the drying aid is not depleted by reaction during cell formation. Rather the drying aid is incorporated into the battery after cell laminate formation thereby remaining available for reaction during battery operation.

The method of the present invention includes tape casting one or all of the individual layers that comprise the cell laminate, advantageously in a dry room, which has a controlled low moisture content. The main component material, which is either the cathode material (a lithium doped inorganic oxide), anode material (carbon) or separator material (ceramic/polymer), is added to a mill with a plasticizer and solvent to form a slurry. The plasticizer typically includes a fluorinated polymer and/or a polymer that is soluble in methanol. The slurry is then tape cast by known methods involving depositing the slurry onto a moving belt to form about a 30-60 μm thick layer. The solvent is then evaporated from the tape, and the polymeric plasticizer cures to form the flexible tape.

The desired cell shapes are then cut out of each flexible tape layer and the laminate is formed by stacking the individual cathode, separator and anode layers and hot pressing them under temperature and pressure sufficient to cause the layers to stick together without distortion. For example, the components may be hot pressed at about 115° C. and about 40 psi. This cell laminate is then subjected to methanol extraction to extract at least some of the plasticizer, that which is soluble in methanol, leaving porosity in the cell structure. Methanol extraction may comprise, for example, washing the laminate repeatedly in a methanol bath for about 20 minutes each wash. The laminate is then vacuum dried, for example at about 40° C., and current collectors are pressed to the exposed anode and cathode surfaces. For example, a copper grid is hot pressed onto the anode side of the laminate at about 120° C. and about 50 psi, and an aluminum grid is hot pressed onto the cathode side of the laminate at about 120° C. and about 50 psi. Alternatively, the current collectors may be pressed onto the laminate during the laminate formation, or after laminate formation but prior to methanol extraction.

The porous cell laminate is then placed in a dry box pre-chamber and pumped down to remove moisture from the structure. By way of example, the tape cast in the dry room may contain about 10,000 ppm moisture, but after pumping down on the tape, the moisture level is decreased to about 1,000-2,000 ppm. Moisture entrained in the cell crystal structure will not, however, be removed by this pumping procedure. The cell laminate is then moved into the dry box (or glove box) and wet with electrolyte, which fills in the pores created by the methanol extraction. The electrolyte is stored in the dry box, which is essentially a moisture-free environment. Drying agents may also be placed in the dry box to absorb any moisture present. The wet cell laminate is then placed into a container and sealed within the dry box. The container is typically a protective bagging material that covers the cell and prevents infiltration of air and moisture.

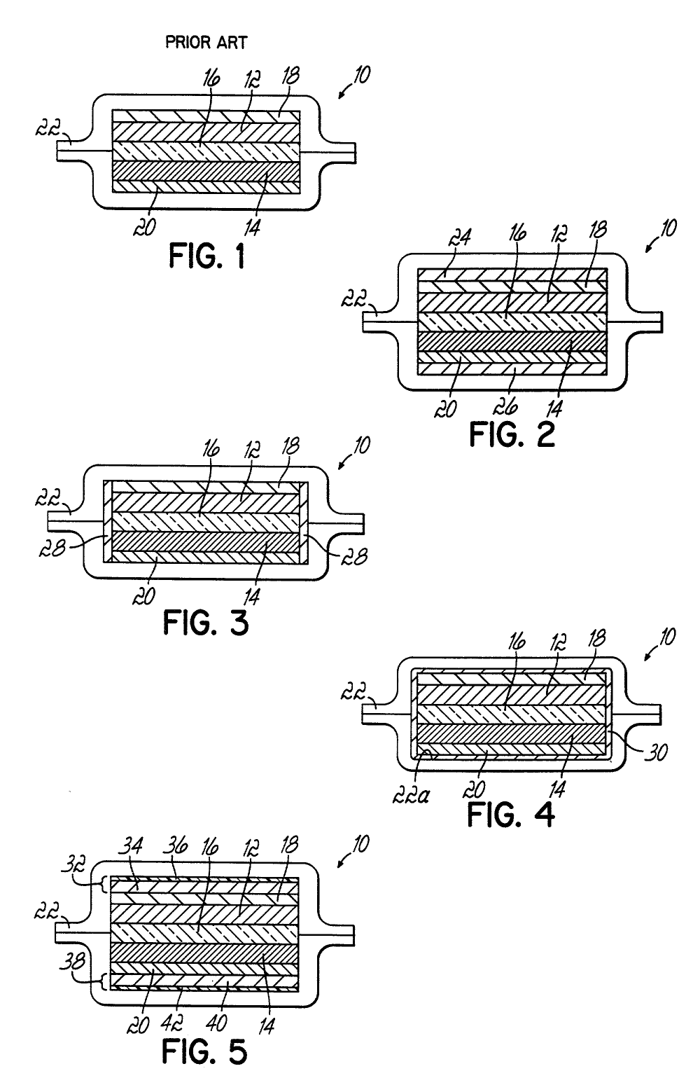

FIG. 1 depicts a single battery cell 10 of the prior art. The cell comprises a cathode material layer 12 and an anode material layer 14 separated by an electrolyte/separator layer 16. Pressed onto the cathode layer 12 is an aluminum mesh current collector 18. Pressed onto the anode layer 14 is a copper mesh current collector 20. This laminated structure is sealed within a bag 22.

In use, water present in cell components 12, 14, 16, 18, 20 is liberated and reacts with metals to form interfering impedance layers around particles that the lithium ions cannot pass through, thereby interfering with the intercalation mechanism. Moreover, under electric current, water reacts with fluorinated polymer plasticizers present in cell components 12, 14, 16 to generate HF, which dissolves the inorganic oxides in the cathode 12, i.e., corrodes the cathode 12. This corrosion places free metal in solution for transfer to the anode 14, which shorts the battery 10. About a 30% drop in capacity occurs during the first charging cycle as a result of these reactions, and that capacity loss cannot be regained, i.e., an irreversible capacity loss.

The present invention decreases this capacity loss during battery use by decreasing the moisture content available for reaction by providing a P₂O₅ drying aid within the sealed cell. This P₂O₅ essentially sponges up the moisture. Water reacts preferentially with P₂O₅ in the cell. Not only does the P₂O₅ react with surface moisture, it also reacts with entrained water as it is liberated from the crystal structure. Furthermore, if HF is formed, the P₂O₅ will react with that compound as well, thereby preventing it from corroding the cathode.

In accordance with the present invention, the P₂O₅ drying aid is added to the battery after the cell laminate is formed, and after the methanol extraction process. In one example of the present invention, P₂O₅ is tape cast, either in the dry room if a dry enough environment can be obtained, i.e. a moisture level below about 500 ppm, or in the dry box, which is an essentially moisture free environment. The P₂O₅ tape could then be added to the cell laminate by applying it to each end of the cell prior to wetting the cell with electrolyte. The battery cell 10 produced thereby is depicted in FIG. 2. The cathode material layer 12 and anode material layer 14 are separated by electrolyte/separator 16 and current collectors 18, 20 are provided at the cathode 12 and anode 14, respectively. A P₂O₅ tape layer 24 is pressed, for example, onto current collector 18 and another P₂O₅ tape layer 26 is pressed onto current collector 20. This structure is then sealed within bag 22.

Alternatively, the P₂O₅ tape could simply be placed in the container with the cell laminate and sealed therein. The battery cell 10 produced by this embodiment is depicted in FIG. 3. The cathode material 12 and anode material 14 are separated by the electrolyte/separator 16 and current collectors 18,20 are provided at the cathode 12 and anode 14, respectively. One or more pieces of tape cast P₂O₅ 28 are placed in the bag 22 and the bag is sealed.

In another example of the present invention, a P₂O₅ powder is mixed with a solvent and loaded into a spray gun. The slurry is then sprayed onto the assembled cell laminate prior to sealing the cell laminate in the container. The resulting battery cell 10 would look similar to that depicted in FIG. 2, but layers 24, 26 would be a slurry instead of tape. Alternatively, the slurry is sprayed onto one or more interior surfaces of the container prior to inserting the cell into the container. FIG. 4 depicts a cell 10 having cathode 12, anode 14, electrolyte/separator 16, and current collectors 18, 20 as described above sealed in a bag 22 having a P₂O₅ slurry layer 30 on the interior surfaces 22a of bag 22. In yet another alternative, the slurry is sprayed onto a substrate, such as a plastic sheet, and the slurry coated substrate is placed in the container prior to sealing the cell laminate therein. FIG. 5 depicts a battery cell 10 having cathode 12, anode 14, electrolyte/separator 16 and current collectors 18, 20 as described above. A layer 32 comprising a P₂O₅ slurry 34 on a plastic substrate 36 is placed adjacent cathode 12 and a layer 38 comprising a P₂O₅ slurry 40 on a plastic substrate 42 is placed adjacent anode 14.

In each of these embodiments of the present invention, the cell laminate is first formed, then the P₂O₅ drying aid is subsequently added such that it lies between an exterior surface of the cell laminate and an interior surface of the container whereby it is not reacted prematurely during cell laminate formation, but rather is available to react with moisture during charging/discharging of the battery.

Although specific examples have been provided in FIGS. 2-5, it should be understood that other methods for adding the P₂O₅ drying aid to the assembled cell laminate exist. For example, while FIG. 2 depicts two P₂O₅ tape layers 24, 26, only one tape layer 24 or 26 could be used. Also, only one cell laminate is depicted in FIGS. 2-5, whereas a typical battery structure includes a bundle or stack of such laminates. Thus, the number of P₂O₅ tape layers may vary depending on the number of cell laminates. By way of further example, FIG. 4 depicts the entire interior surface 22a having the P₂O₅ slurry coating 30, but it should be understood that less than the entire interior surface could be coated. Further, while tape casting has been described as the method for fabricating the cell components, other methods may be used, with P₂O₅ being applied as described above to the resulting cell laminate.

The present invention may be used in conjunction with other now known or hereafter developed techniques for reducing moisture content in lithium batteries. Moisture should still be rigorously avoided during fabrication of the battery cells. The addition of the present invention with such techniques, however, results in a significant improvement in battery life.

While the present invention has been illustrated by the description of embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of applicant's general inventive concept.

What is claimed is:

1. A method for manufacturing a lithium battery comprising:
fabricating a cell laminate comprising a transition metal chalcogenide positive electrode and a carbonaceous negative electrode in opposing relation with an electrolyte-containing separating layer therebetween;
sealing in a container one or more cell laminates to form a battery; and
prior to sealing, providing a P₂O₅ drying aid between an exterior surface of the cell laminate and an interior surface of the container.

2. The method of claim 1, wherein the transition metal chalcogenide is a lithiated manganese oxide.

3. The method of claim 1, wherein the carbonaceous electrode comprises graphite.

4. The method of claim 1 further comprising fabricating the positive electrode, negative electrode, and separating layer each by mixing a main component material with a binder in a solvent to form a slurry, tape casting the slurry and extracting the solvent to form a flexible tape of the main component material and binder.

5. The method of claim 4, wherein the binder includes a polymer soluble in methanol, and the method further comprises extracting the polymer by contact with methanol to create pores throughout the main component material which are subsequently filled with the electrolyte.

6. The method of claim 1, wherein the providing of the P₂O₅ drying aid includes tape casting P₂O₅ and pressing the P₂O₅ tape onto the exterior surface of the cell laminate prior to sealing in the container.

7. The method of claim 1, wherein the providing of the P₂O₅ drying aid includes tape casting P₂O₅ and placing the P₂O₅ tape into the container with the cell laminate prior to sealing the one or more cell laminates in the container.

8. The method of claim 1, wherein the providing of the P₂O₅ drying aid includes forming a slurry of P₂O₅ powder and coating the slurry onto the interior surface of the container prior to sealing the one or more cell laminates in the container.

9. The method of claim 1, wherein the providing of the P₂O₅ drying aid includes forming a slurry Of P₂O₅ powder and coating the slurry onto the exterior surface of the cell laminate prior to sealing the one or more cell laminates in the container.

10. The method of claim 1, wherein the providing of the P₂O₅ drying aid includes forming a slurry of P₂O₅ powder, coating the slurry onto a substrate, and placing the coated substrate in the container prior to sealing the one or more cell laminates in the container.

11. A method for manufacturing a lithium battery comprising:
fabricating a transition metal chalcogenide positive electrode and a carbonaceous negative electrode;
assembling the electrodes in opposing relation with a separator layer therebetween to form a cell laminate;
extracting a binder component used in fabricating each of the positive electrode, negative electrode and separator to create porosity in the cell laminate;
wetting the cell laminate with an electrolyte; and
sealing in a container one or more wetted cell laminates to form a battery,
wherein a P₂O₅ drying aid is provided in the battery after the extracting step.

12. The method of claim 11, wherein the transition metal chalcogenide is a lithiated manganese oxide.

13. The method of claim 11, wherein the carbonaceous electrode comprises graphite.

14. The method of claim 11 further comprising fabricating the positive electrode, negative electrode, and separator layer each by mixing a main component material with a binder in a solvent to form a slurry, tape casting the slurry and extracting the solvent to form a flexible tape of the main component material and binder.

15. The method of claim 11, wherein the providing of the P₂O₅ drying aid includes tape casting P₂O₅ and pressing the P₂O₅ tape onto the exterior surface of the cell laminate prior to sealing in the container.

16. The method of claim 11, wherein the providing of the P₂O₅ drying aid includes tape casting P₂O₅ and placing the P₂O₅ tape into the container with the cell laminate prior to sealing the one or more cell laminates in the container.

17. The method of claim 11, wherein the providing of the P₂O₅ drying aid includes forming a slurry of P₂O₅ powder and coating the slurry onto the interior surface of the container prior to sealing the one or more cell laminates in the container.

18. The method of claim 11, wherein the providing of the P₂O₅ drying aid includes forming a slurry of P₂O₅ powder and coating the slurry onto the exterior surface of the cell laminate prior to sealing the one or more cell laminates in the container.

19. The method of claim 11, wherein the providing of the P₂O₅ drying aid includes forming a slurry of P₂O₅ powder, coating the slurry onto a substrate, and placing the coated substrate in the container prior to sealing the one or more cell laminates in the container.

20. A method for manufacturing lithium battery cells comprising:
fabricating a transition metal chalcogenide cathode, a separator, and a carbonaceous anode, each by tape casting a slurry comprising a main component material, a solvent, a fluorinated polymer, and a polymer soluble in methanol;
assembling the cathode, the separator, and the anode into a cell laminate;
immersing the cell laminate in methanol to extract the polymer soluble in methanol to create porosity in the cell laminate;
wetting the cell laminate with an electrolyte; and
sealing one or more wetted cell laminates in a container to form a battery,
wherein a P₂O₅ drying aid is provided in the battery after the extracting step by a method selected from the group consisting of:
(a) tape casting P₂O₅ and applying the P₂O₅ tape to an exterior surface the cell laminate prior to wetting;
(b) tape casting P₂O₅ and inserting the P₂O₅ tape into the container prior to sealing;
(c) applying a P₂O₅ slurry to an interior surface of the container prior to sealing;
(d) applying a P₂O₅ slurry to an exterior surface of the cell laminate prior to sealing in the container; and
(e) applying a P₂O₅ slurry to a substrate and inserting the substrate into the container prior to sealing.
